(19) United States
(12) Patent Application Publication
(10) Pub. No.: US 2022/0258322 A1
(43) Pub. Date: Aug. 18, 2022

(54) DENTAL MODELS AND RELATED METHODS

(71) Applicant: Align Technology, Inc., San Jose, CA (US)

(72) Inventors: Allen R. BORONKAY, San Jose, CA (US); Avi KOPELMAN, Palo Alto, CA (US); Srinivas KAZA, San Francisco, CA (US)

(21) Appl. No.: 17/740,177

(22) Filed: May 9, 2022

Related U.S. Application Data
(63) Continuation of application No. 16/400,669, filed on May 1, 2019, now Pat. No. 10,603,781.
Application No. 16/400,669 is a continuation of application No. 15/155,995, filed on May 16, 2016, now Pat. No. 10,299,899.
Application No. 15/155,995 is a division of application No. 13/773,229, filed on Feb. 21, 2013, now Pat. No. 9,375,298.
(60) Provisional application No. 61/601,448, filed on Feb. 21, 2012.

(51) Int. Cl. B25G 1/10; B25G 1/06; B25G 1/04

(52) U.S. Cl. CPC B25G 1/102; B25G 1/04; B25G 1/06

(57) ABSTRACT

A dental model and related systems and methods, including a first component representing a portion of a patient's jaw and a second component that is demountably attachable to the first component, and a second component representing a dental structure of interest, such as the remaining portion of a tooth or a dental implant.

### CROSS-REFERENCE

This application is a continuation of U.S. patent application Ser. No. 16/400,869, filed May 1, 2019, which is a continuation of U.S. patent application Ser. No. 15/155,995, filed May 16, 2016, now U.S. Pat. No. 10,299,899, issued May 28, 2019, which is a divisional of U.S. patent application Ser. No. 13/773,229, filed Feb. 21, 2013, now U.S. Pat. No. 9,375,298, issued Jun. 28, 2016, which claims the benefit of U.S. Provisional Patent Application No. 61/601,448, filed Feb. 21, 2012, the entire contents of which are incorporated by reference.

### BACKGROUND OF THE INVENTION

The present invention relates generally to dental models, and more particularly to dental models having a jaw component and demountable components, such as tooth components and/or implant analogue components, that can be accurately mounted to the jaw component and removed multiple times. In many embodiments, the dental models disclosed herein can be fabricated using additive manufacturing techniques such as stereo-lithography (SLA) and three-dimensional printing.

In the preparation of dental crowns, bridges, and implants, a physical model of the jaw is often used. These jaw models represent the patient's jaw in the vicinity of the crown(s), bridge(s), or implant(s) being prepared. Existing approaches for the preparation of these jaw models have included milling the jaw model from a solid block of material. Such milled jaw models, however, lack desirable features, such as demountable portions that can be accurately positioned when mounted and selectively removed to better facilitate the preparation of the applicable dental crown, bridge, and/or implant.

Thus, improved dental models and related methods are desirable, particularly dental models with demountable portions that can be repeatedly accurately mounted and demounted.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The present invention includes dental models, as well as related systems and methods, including methods of use and manufacture or fabrication. In one embodiment, a dental model can include a first component configured to represent a portion of a patient's jaw and a second component that is demountably attachable to the first component. The second component can represent a dental structure of interest, such as the remaining portion of a tooth or a dental implant. The interface between the first and second components includes contact with locally protruding portions on the first component and/or on the second component. In many embodiments, the first component defines a socket and the second component includes a shaft that is received by the socket and interfaces with the socket. The locally protruding portions provide increased compliance that accommodates a design range of interference fit between the first and second components.

For a fuller understanding of the nature and advantages of the present invention, reference should be made to the ensuing detailed description and accompanying drawings.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

FIG. 1 is an exploded view showing a portion of a dental model, in accordance with many embodiments, that includes a jaw component having a socket with a folded spring, a tooth component having a shaft portion configured for insertion into the socket, and a screw that mates with the shaft.

FIG. 2 shows the dental model of FIG. 1 with the tooth portion of the tooth component shown as semi-transparent to show interface details between the shaft and the socket, including contact between the folded spring and the shaft.

FIG. 3 is a cross-sectional view through the socket, the shaft portion of the tooth component, and the folded spring.

FIG. 4 shows the tooth component of the dental model of FIG. 1.

FIG. 5 shows a dental model tooth component, in accordance with many embodiments, that has a rectangular-shaped shaft portion.

FIG. 6 shows a dental model jaw component having a socket configured to receive the tooth component of FIG. 5, in accordance with many embodiments.

FIG. 7 is an exploded view showing a portion of a dental model, in accordance with many embodiments, that includes the tooth component of FIG. 5, the jaw component of FIG. 6, and a screw that mates with the tooth component rectangular-shaped shaft.

FIG. 8 shows a dental model tooth component, in accordance with many embodiments, that has a generally rectangular-shaped shaft portion having a projection portion that may be used to verify insertion depth.

FIG. 9 is a partially exploded view showing a portion of a dental model, in accordance with many embodiments, that includes a jaw component having sockets each with four opposing pairs of compliance features, and tooth components in accordance with the tooth component of FIG. 8.

FIG. 10 is an exploded view showing a portion of a dental model, in accordance with many embodiments, that includes a jaw component having a socket with sets of cantilevered springs and a tooth component having a three-lobed “tripod” shaft portion.

FIG. 11 shows the socket of the jaw component of FIG. 10.

FIG. 12 shows a socket of a jaw component, in accordance with many embodiments, configured to receive a three-lobed “tripod” shaft portion of a tooth component such as the tooth component of FIG. 10.

FIG. 13 shows a tooth component, in accordance with many embodiments, having a three-lobed “tripod” shaft portion having a projection portion that may be used to verify insertion depth.

FIG. 14 shows a dental model component, in accordance with many embodiments, having a rectangular-shaped shaft having longitudinal compliance features and with a projection portion that may be used to verify insertion depth.

FIG. 15 shows a dental model component, in accordance with many embodiments, having a rectangular-shaped shaft having upper and lower transversely-oriented compliance features and with a projection portion that may be used to verify insertion depth.

FIG. 16 and FIG. 17 show dental model tooth components, in accordance with many embodiments, having a rectangular-shaped shaft with hollow upper and lower transversely-oriented compliance features and top stop detent features.

FIG. 18 is a cross-sectional view through a portion of a dental model, in accordance with many embodiments, that includes a dental model component and a jaw component, the dental model component having upper and lower transversely-oriented compliance features and a top stop detent feature, and the jaw component having transversely-oriented sidewall recesses.

FIG. 19 shows a dental model, in accordance with many embodiments, in which dental model components having upper and lower transversely-oriented compliance features, snap-hooks, and bottom stop surfaces are shown disposed within sockets of a jaw component of the dental model.

FIG. 20 shows a dental model tooth component, in accordance with many embodiments, that has upper and lower transversely-oriented compliance features, snap-hooks, and bottom stop surfaces.

FIG. 21 shows a dental model component, in accordance with many embodiments, that has spherical compliance features and is configured to be received within a socket of a jaw component having stepped sidewalls.

FIG. 22 shows the dental model component of FIG. 21 disposed within a socket of a jaw component having stepped sidewalls, in accordance with many embodiments.

FIG. 23 shows a dental model component, in accordance with many embodiments, has spherical compliance features and longitudinal stiffening ribs disposed between the spherical compliance features.

FIG. 24, FIG. 25, and FIG. 26 show dental model implant analog components, in accordance with many embodiments, that have a tab feature that mates with a corresponding slot in jaw component.

FIG. 27 and FIG. 28 show a dental model jaw component, in accordance with many embodiments, that has a socket with multiple compliance features and an orientation recess.

FIG. 29, FIG. 30, and FIG. 32 are cross-sectional views showing a dental model implant analog component mounted in a jaw component, in accordance with many embodiments.

FIG. 31 is a plan view showing a dental model implant analog component mounted in a jaw component, in accordance with many embodiments.

FIG. 33 shows a dental model implant analog component, in accordance with many embodiments, that has a flat side surface for use in orienting the implant analog component relative to a receiving jaw component.

FIG. 34 shows a dental model jaw component, in accordance with many embodiments, that has a socket with an orientation feature, the socket being configured to receive and orient the implant analog component of FIG. 33.

### DETAILED DESCRIPTION OF THE INVENTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

In the preparation of dental crowns, bridges, and implants, a physical model of the jaw of a patient is often used. The physical model can include one or more preparations and/or one or more input analogs, as appropriate for the application. In the past, these models were generally milled from a solid block of material.

Advantageously, the dental models disclosed herein can be made using additive manufacturing (AM) techniques such as stereolithography (SLA) and 3D printing. The difference in material properties and the manufacturing techniques for dental models that can be made using AM techniques as compared to traditional milled dental models give rise to different requirements and priorities in the design of the models. If, however, a material used to fabricate a dental model as disclosed herein has suitable mechanical properties, the dental model may also be fabricated using existing milling techniques. Constraints on model geometry associated with existing milling techniques, however, may limit the application of existing milling techniques in the fabrication of the dental models disclosed herein.

The models disclosed herein generally include two or more components. One component represents a portion of a patient's jaw in the vicinity of the applicable crown(s), bridge(s), and/or implant(s) to be prepared. This first component is also referred to herein as a jaw component. One or more other components are made that are detachably mountable to the jaw component. These one or more other components represent, for example, each tooth to be crowned and/or each tooth that will support a bridge. These one or more other components can be made to match, typically as closely as possible, the corresponding actual dental geometry of the patient. For example, for the preparation of a crown, a component can represent the geometry of the remaining portion of the tooth to be crowned. Such a component may be referred to herein as a “die” since it can be used as a die to form interfacing portions of the crown that is prepared. Such a component may also be referred to herein as a “tooth component”. When dental implants are involved, one or more of these other components can represent the abutment mounting features of the implant(s) as they are located in the patient's jaw. Such components that represent abutment mounting features of an implant(s) may be referred to herein as an “implant analog component.” Each of these other components (e.g., die, tooth component, implant analog component) have features configured to interface with corresponding features of the jaw component such that these other components can be repeatedly mounted to the jaw component so as to be accurately located relative to the tooth and gingiva geometry on the jaw component.

In many embodiments, the jaw component includes at least one socket configured to interface with a shaft portion of a die, tooth component, and/or implant analog component. The socket(s) and/or the shaft portion(s) need not be a single continuous shape. For example, the shaft portion can include two separate shaft segments that mate with a socket that includes two corresponding receptacles. And while in the examples and embodiments described herein the socket is generally concave and the shaft is generally convex (as illustrated by the choice of terminology), any other suitable configurations in conformance with the coupling approaches described herein can be used.

To facilitate the fabrication of crowns or bridges, one or more dice and/or one or more tooth analog components may be mounted to and demounted from the jaw component a number of times. One or more implant analog components may also be mounted to and demounted from the jaw component a number of times, though typically only a few times. It is a design goal of the dental models disclosed herein that each time the die, tooth component, and/or implant analog component is inserted that it reach and remain in a position that accurately represents the position of the corresponding preparations and/or implants in the patient's jaw.

Milled dental models are generally made from relatively stiff materials. Properly executed, existing milling techniques can produce a highly accurate finished surface. Existing milling techniques, however, may be limited in their ability to produce small features due to cutter diameter limitations arising from strength, wear, machining time, and cost considerations. In some milled models, the socket and shaft have matching sections taken across insertion direction with the addition of a very small clearance between these two components. Friction between these components is used to keep these components coupled together in a desired relative position. In such a design, a trade-off is made between having a relatively small clearance to keep the position accurate and constant and having a relatively large clearance that may be necessary so that the die, tooth component, and/or analog can be inserted into the socket without friction induced jamming that may arise due to tolerance variations and/or misalignment. Additionally, milled models may also require the use of expensive four- or five-axis milling machines, special cutters (with further diameter limitations), and/or multiple set-ups to create geometry with undercuts as is typical on teeth.

AM materials can have a fairly wide range of mechanical properties. AM materials include suitable polymers. For a dental model geometry that is theoretically machinable, currently available AM machines may not achieve as accurate a surface as is possible by milling. Currently available AM machines are, however, able to produce much smaller concave features than milling and are able to produce undercuts without further special considerations. Although AM machine generated surfaces may have artifacts due to the layering and sometimes lateral resolution, state-of-the-art AM machines can more easily produce small curved details better than existing milling techniques. AM layering effects, however, can cause problems. For example, when two AM fabricated components slide against each other perpendicular to the layering direction, layering effects can create mechanical interlocking that generates high sliding frictional forces.

In the dental models disclosed herein, excessive sliding frictional forces are avoided by including one or more compliant features (or locally protruding portions) as part of the shaft, the socket, or both. The compliant features are configured to accurately locate the shaft in the socket. The compliant features are designed with dimensions and placement to accommodate manufacturing variations in the shaft and socket such that the components can be coupled together in all possible combinations of large and small sockets and shafts without generating too high or too low of the associated interface forces. For example, when a shaft having a minimum dimension is coupled to a socket having a maximum dimension, there is still a suitable level of contact between the compliant portions and their mating features so that the compliant features will have a suitable minimum level of compression, thereby generating a suitable minimum force between the components such that the shaft is not loose in the socket. This minimum force is sufficiently high to generate a friction force sufficient to keep the shaft from moving relative to the socket. In the tightest fit scenario, the compliance features are configured to accommodate the increased level of compression without generating interface forces that are above a suitable level. The compliance features are configured to accommodate the overall range of possible compression levels through a combination of geometry and material properties, examples of which are described herein.

The compliant features (or locally protruding portions) can be configured in a variety of ways, e.g., to include a compliance configured to accommodate an interference fit between the components described herein (e.g., between a jaw component and a tooth component). In some embodiments, the compliant features (or locally protruding portions) can have a compliance (or compression property) that allows for the features to compress when one component (e.g., a jaw component) is engaged with another component (e.g., a tooth component). This compliance (e.g., ability to compress) can be tailored to provide a desired interference fit between the two components.

In certain aspects, the structure and/or position of the compliant features (or locally protruding portions can be configured to achieve a desired interference fit. For example, locally protruding portions can be formed on a shaft portion of a tooth component. The dimensions of the shaft can be configured to fit in a socket of a jaw component. To achieve a desired interference fit between the components, the locally protruding portions can be made to have a structure that expands the local dimensions of the shaft such that there is an overlap between the width of the shaft and the width of the socket. Due at least in part to the configured compliance (or compressive property) of the locally protruding portion, the shaft can be fit securely and accurately in the socket with minimal, if any, movement between the tooth and jaw components. Depending on the properties (e.g., compliance) of a material, the locally protruding portions (or compliant features) can be manufactured to have dimensions that correspond with a given compliance for the material. In an example embodiment, a socket in a jaw component may have a width of about 5 mm. The shaft of the tooth component can similarly have a width of about 5 mm. Owing to, e.g., error in a manufacturing process, the shaft and socket may not fit properly together. Locally protruding portions (or compliant features) can be used to produce a desired interference fit between the two components. For example, a locally protruding portion on the shaft and/or the socket can be made to increase the width of either the shaft and/or socket by a predetermined dimension. In some embodiments, the locally protruding portion (or compliant feature) can be configured to increase the width of the shaft or socket by 50 microns. Due at least in part to the compliance of the locally protruding portion, the locally protruding portion can compress and allow for a desired interference fit between the two components. In some embodiments, the locally protruding portion can be designed to increase dimensions of one component compared to another component over a wide range. For example, a dimension (e.g., width) of one component can be longer than a dimension of a second component over a range, such as between about 10 microns to about 100 microns, between about 20 microns to about 80 microns, or from about 40 microns to about 60 microns. In some embodiments, the dimension of one component (e.g., a shaft of a component) can be different than another component (e.g., a socket) by a predetermined percentage. For example, a width of a shaft at a locally protruding portion can be about 1%, or about 2%, or about 3%, or about 4% or about 5% wider than a socket width. It will be generally recognized by one of ordinary skill in the art that a variety of dimensions can be manufactured and used to tailor both compliance of the protruding portions and/or interference fit between the components. In certain embodiments, the compliance can be tailored according to the material used to make the components and/or by the shape or structure of the compliant feature. For example, folded springs can be used generate compliant features that are more compliant than, e.g., a ridge or ball structure on a component. The spring, e.g., can be structurally designed to compress upon application of force due in-part to the structure of the spring. The ridge or ball structure may have a compliance that is more dependent on the compliance properties of the material used to make the components. The various combinations of compliance for the various compliant features (or locally protruding portions) described herein and tailored interference fit between the various components described herein can be predetermined according to factor such as the properties of the materials, the dimensions of the locally protruding portions, and/or the locations of the locally protruding portions.

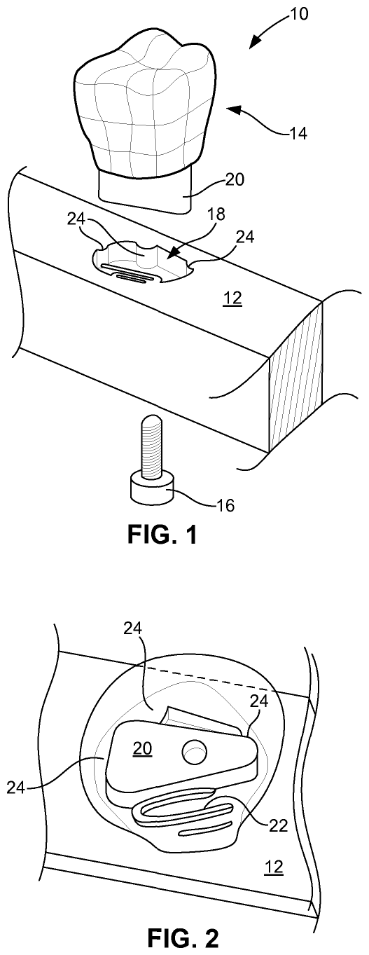

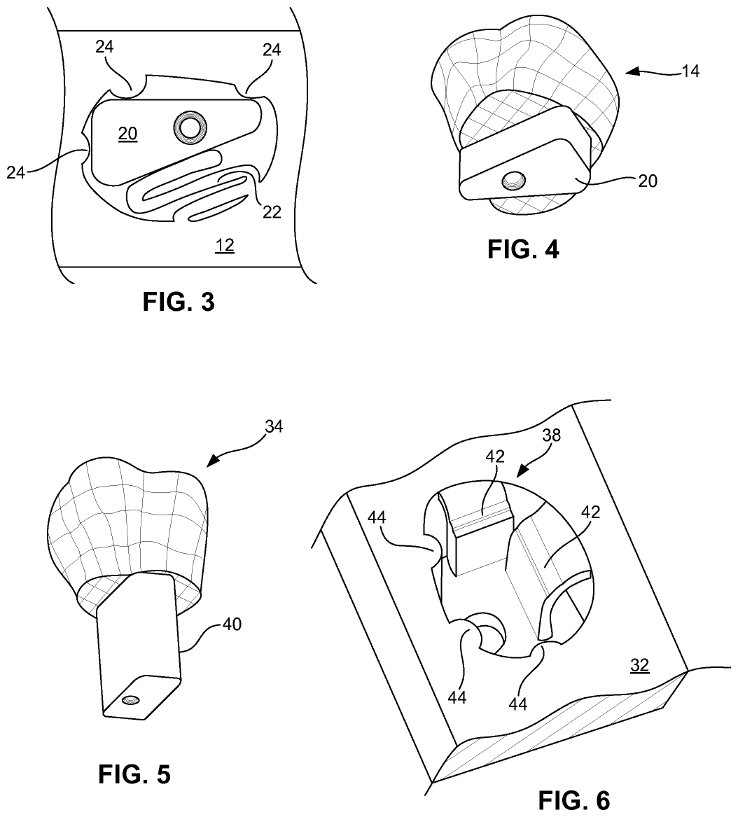

Referring now to the drawings, in which like reference numerals represent like parts throughout the several views, FIG. 1 through FIG. 4 illustrate a dental model 10, in accordance with many embodiments, that includes a jaw component 12, a tooth component 14, and a screw 16. The jaw component 12 defines a socket 18. The tooth component 14 has a shaft portion 20 that is received by the socket 18. A serpentine member 22 (folded spring) is formed as an integral part of the jaw component 12 and is disposed within the socket 18. When the shaft portion 20 is mounted in the socket 18, the presence of the shaft portion 20 deflects the serpentine member 22, thereby generating an interface force between the serpentine member 22 and the shaft portion 20. The interface force pushes on a face of the shaft portion 20 that is oriented such that components of the interface force act to register two faces of the shaft portion 20 against three cylindrical portions 24 of the socket 18 to provide repeatable positioning of the shaft portion 20 lateral to the insertion direction of the shaft portion 20. The screw 16 mates with the shaft portion 20 through a hole in the jaw component 12 to anchor the shaft portion 20 securely in the socket 18. The bottom face of the shaft portion 20 is held against the bottom face of the socket 18 (not shown) by the screw 16 to control the position of the shaft portion 20 in the insertion direction relative to the jaw component 12.

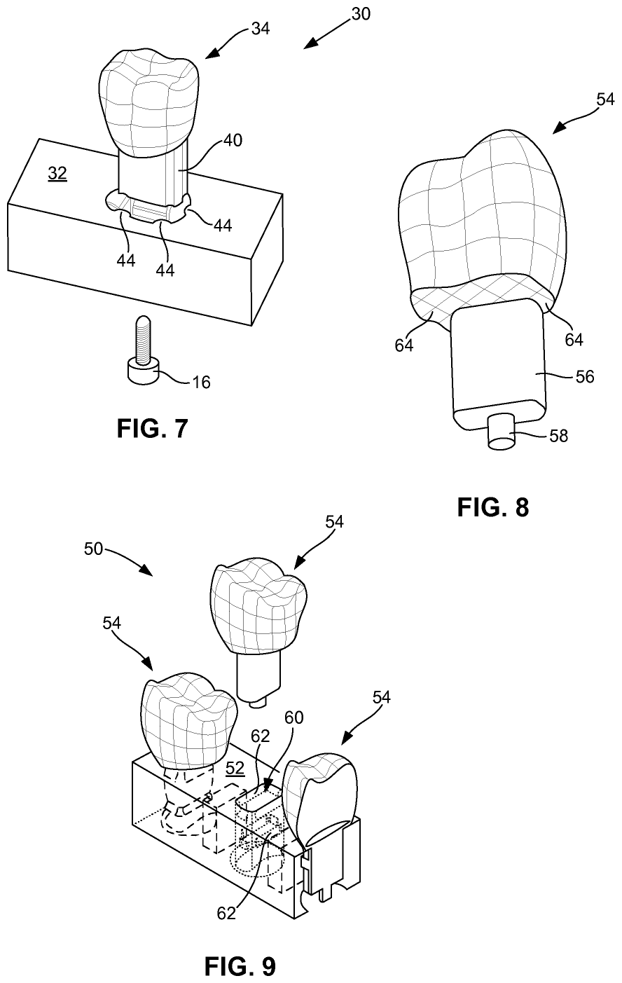

FIG. 5 through FIG. 7 illustrate a dental model 30, in accordance with many embodiments. Dental model 30 includes a jaw component 32, a tooth component 34, and a screw 16. The jaw component 32 defines a socket 38. The tooth component 14 has a shaft portion 40 that is received by the socket 38. The dental model 30 is configured similar to the dental model 10, but includes a shaft portion 40 with a generally rectangular shape. Two cantilevered springs 42 are formed as integral parts of the jaw component 32 and are disposed within the socket 38. When the shaft portion 40 is mounted in the socket 38, the presence of the shaft portion 40 deflects each of the cantilevered springs 42, thereby generating an interface force between each of the cantilevered springs 42 and the shaft portion 40. The interface forces push the shaft portion 40 into registration with protruding cylindrical portions 44 of the socket 38 to provide repeatable positioning of the shaft portion 40 lateral to the insertion direction of the shaft portion 40. The screw 16 mates with the shaft portion 40 through a hole in the jaw component 32 to anchor the shaft portion 40 securely in the socket 38. The bottom face of the shaft portion 40 is held against the bottom face of the socket 38 (not shown) by the screw 16 to control the position of the shaft portion 40 in the insertion direction relative to the jaw component 32. Although the screw 16 is used in the dental model 30, any suitable type of fastener can be used.

In the dental models 10, 30, the lateral position accuracy depends on the positional accuracy of the interfacing registration surfaces of the shaft portion and the socket. The lateral position accuracy of existing AM techniques, however, may be insufficient to produce a desired level of positional accuracy. In general, the insertion direction for the shaft portion may not be perpendicular to the AM build layers, so it may not be possible to ensure that side walls of the registration features are exactly aligned with positions that can be built by the AM device (i.e. not between steps of a stepper motor or between counts of an encoder used to position the laser or print head). In this case, better accuracy may be achieved by averaging the errors of opposing faces of the shaft or socket, a concept that can be extended from rectangular through polygons with more sides and also to circular, elliptical, or other shapes.

FIG. 8 and FIG. 9 illustrate a dental model 50, in accordance with many embodiments, that makes use of the opposing compliance concept. Dental model 50 includes a jaw component 52 and multiple tooth components 54. Each tooth component 54 has a generally rectangular-shaped shaft portion 56 having a projection portion 58 that may be used to verify insertion depth. The jaw component 52 defines multiple sockets 60. There are eight compliant features 62 arranged in four opposing pairs in each of the sockets 60 with two pairs near the top of the socket 60 and two near the bottom of the socket 60. In this embodiment, the compliant features 62 are protruding triangular prism portions of the jaw component 52. The triangular prism shape has a non-linear stiffness when compressed towards the side walls of the socket 60 by the shaft portion 56. If opposing compliant features have the same dimensions, the non-linearity strongly favors centering the shaft portion 56 between the opposing compliant features for consistent positioning. In this embodiment, the position in the insertion direction is controlled by pressing a lip 64 at the top of the shaft portion 56 against a flat surface at the top of the socket 60. Friction holds each of the tooth components 54 in place when mounted to the jaw component 52.

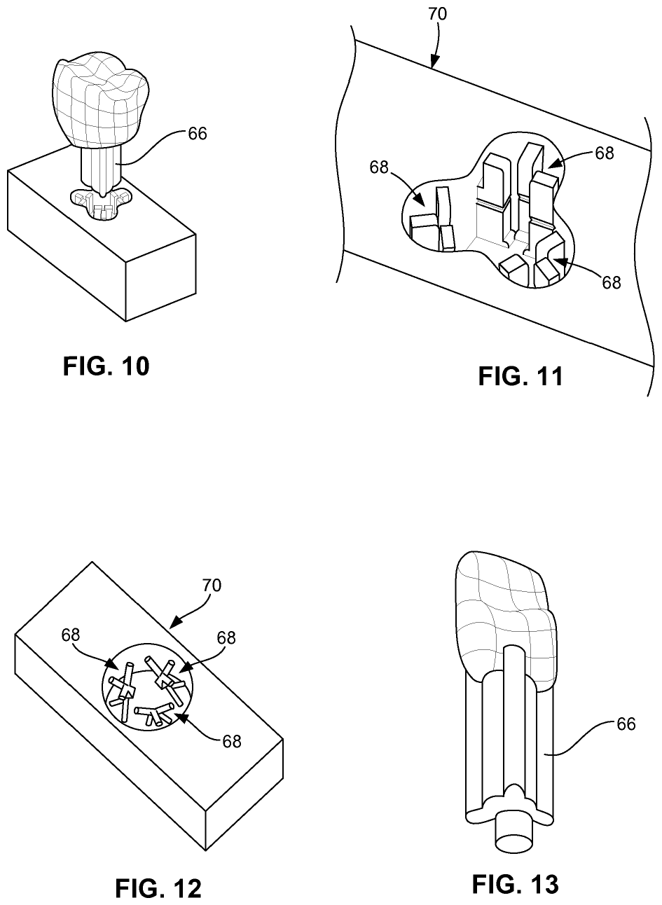

FIG. 10 through FIG. 13 illustrate components of dental models that use a three-lobed “tripod” shaft 66. Each lobe interacts with a set of cantilever springs 68 built into a socket 70. The cantilever springs can be easily reconfigured to tune their compliance behavior, but their relatively small dimensions place higher requirements on the material properties to maintain integrity.

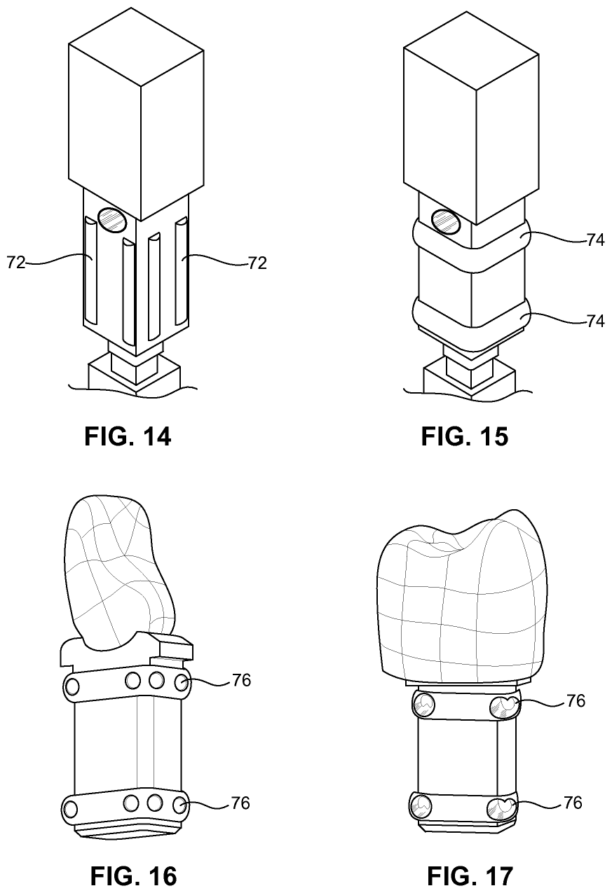

FIG. 14 and FIG. 15 show variations on the rectangular shaft. In these embodiments, the compliant features are part of the shaft instead of the socket. In FIG. 14, the compliant features are eight ribs 72 extending longitudinally, two on each face of the shaft. The ribs 72 have a generally triangular cross section except that the tip is rounded. A sharp tip may be prone to breakage. In FIG. 15, the compliant features are two ribs 74 extending transversely around the shaft. For longitudinal ribs, the shaft is guided all the way in, but the friction builds as the shaft is inserted and a larger area of the ribs is compressed. If not sized correctly, or if manufacturing tolerances are too loose such that it cannot be sized correctly, the shaft will either be loose in the socket or the friction forces will be high, making insertion and removal difficult. As will be discussed in regards to FIG. 22, the interfacing regions of the shaft and the socket can be “stepped” to avoid overly large contact areas. The use of “stepped” interface regions can be applied in any suitable fashion to any suitable dental model design that includes compliant features.

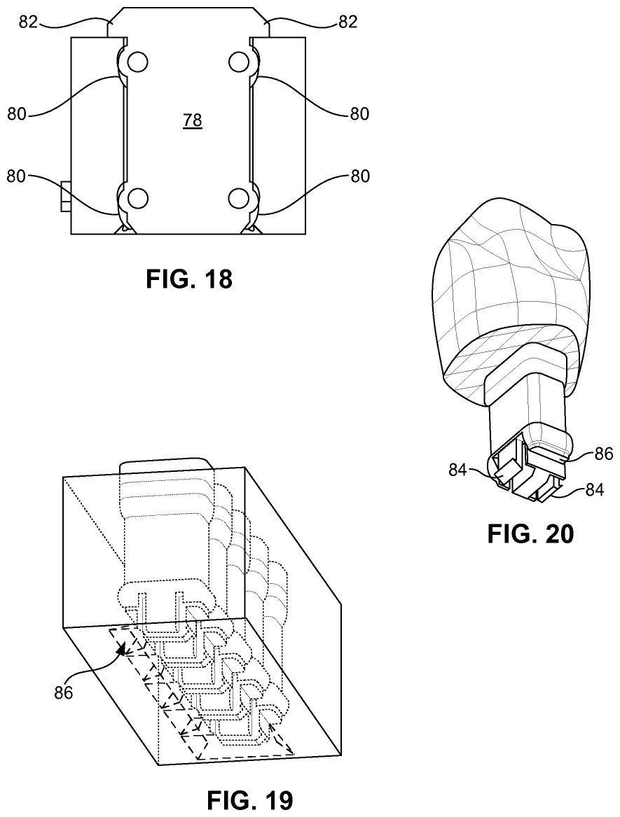

FIG. 16 through FIG. 18 show more embodiments that utilize rectangular-shaped shafts. In these embodiments, ribs 76 are hollowed to provide increased compliance relative to solid ribs. In FIG. 18, a shaft portion 78 is shown seated in a socket. The socket has depressions 80 in its surface designed to mate with the ribs 76 to form a snap fit that tends to pull the shaft 78 into a detent position. In this embodiment, a lip 82 at the top of the shaft portion 78 is stopped by the top of the socket before the ribs 76 are fully engaged into the detent position so that the lip 82 determines the final position. The lip 82 can be omitted, in which case, the position in the insertion direction would be determined by the balance of forces between the ribs 76 and the depressions 80 in the socket.

FIG. 19 and FIG. 20 show another embodiment similar to those in FIG. 16 through FIG. 18 except that the ribs are not hollowed and a snap fit is generated by separate hooks 84 near the bottom of the shaft that engage with a sloped opening 86 at the bottom of the socket. In many embodiments, the slope of the hook surface and of the mating surface on the socket is configured so that the snap fit is not permanent and the die can be removed easily. It is also possible to configure the slope of the hook surface and of the mating surface on the socket so that the die can only be removed by manipulating a feature on the hook 84 to disengage the hook 84 from the socket. In this embodiment, the position in the insertion direction is determined by the interaction of shoulder surfaces 86 near the bottom of the shaft and mating socket surfaces near the bottom of the socket.

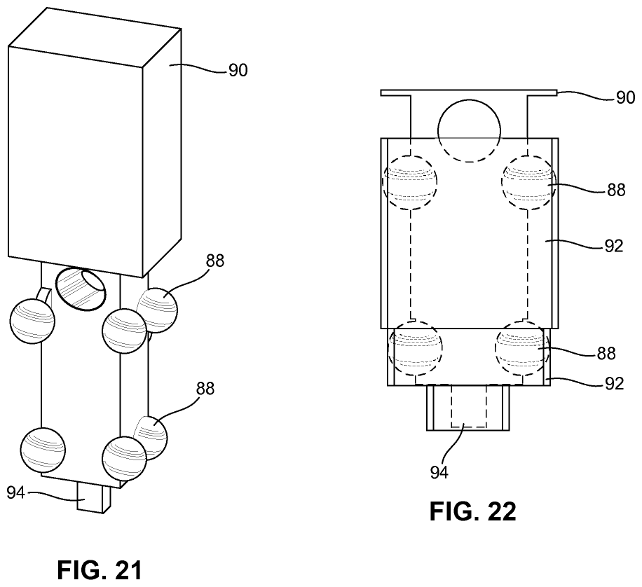

FIG. 21 and FIG. 22 show another embodiment that can be used, for example, for crowns and bridges. In this embodiment, the compliance portion is a set of spherical features 88 on the shaft. The spherical shape has a non-linear stiffness with the advantages discussed above for FIG. 8 and FIG. 9. The compliance is easily manipulated by choosing the radius and amount of overlap of the spherical feature 88 with the body of the shaft. Other suitable shapes can also be used. For example, an ellipsoid can be used with the narrow equators against the socket walls to increase the compliance for a given overall size. As shown, each sphere 88 contacts the socket at two points on adjacent faces of the socket. Alternate embodiments can be configured such that only one point on each sphere 88 makes contact with an adjacent face of the socket. For example, each of the longitudinal ribs in FIG. 14 can be replaced by two spheres, one near the top of the shaft and one near the bottom.

The number of contacts can be reduced, for example, until there are only six contact points, which define a kinematic mount. The addition of a suitably placed seventh contact can create an opposing force on the other contact points, so that the shaft is firmly positioned in the socket, rather than being dependent on an outside force, typically gravity, to ensure that all the contacts remain touching. In practice, because of resolution limitations associated with AM fabrication of a single surface, it may be preferable to use a greater number of opposed contacts to average out the position error of the surfaces.

While most of the embodiments described herein use a rectangular shaft, any other suitable shape, for example a triangular shaft, can also be used. The shaft shape employed can be somewhat independent of the number of contacts. For example, instead of using four contact spheres near the bottom of the shaft and four near the top, three near the bottom and three near the top can be used with each sphere having two points of contact with adjacent faces of the socket. A shaft of any suitable shape (e.g., triangular, rectangular, pentagon, etc.) can be used to connect the spheres.

Note that the hole through the shaft shown in FIG. 21 and FIG. 22 is for prototyping purposes and can be omitted. In these figures, a rectangular prism 90 represents the portion that would have the shape of the preparation. As shown in FIG. 22, the socket has walls 92 parallel to the insertion direction, but the walls 92 are stepped so that the lower set of compliance portions are loose in the socket until they reach the step near the bottom of the socket. This keeps the insertion force near zero until the shaft is almost fully inserted into the socket. A projection 94 at the bottom of the shaft extends through a hole in the jaw component and is positioned and shaped such that its end surface is flush with the bottom of the jaw component. This enables easy checking that the shaft is fully inserted into the socket as any error would be apparent by the unevenness of the projection 94 relative to the bottom of the jaw component. Note that for the contact that sets the position in the insertion direction, high compliance is undesirable unless there are two opposing compliant contacts, as can be provided in an embodiment similar to the embodiment of FIG. 18 but without the lip. For a single contact, a hard stop in the insertion direction provides for well-defined and repeatable positioning.

Most of the embodiments described herein have the compliant features on the shaft. Nearly all of the described embodiments, however, can be reconfigured to place the compliant features on the socket instead. Additional embodiments can use a mixture of locations for the compliant features with some on the shaft and some on the socket. For AM techniques using a solid support material, such as Objet, it may be preferable to put the compliant features on the shaft in order to avoid small concave features from which the support material is difficult to remove, assuming that the shaft is the generally convex and the socket concave as in many embodiments. For other AM techniques, other considerations may guide the choice of where to locate the compliant features.

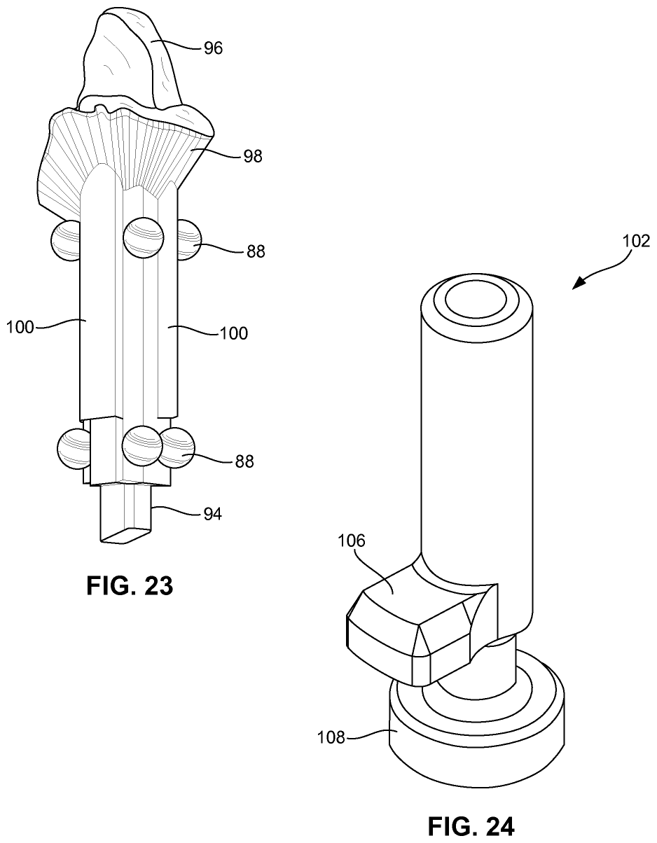

FIG. 23 shows an improved embodiment of the embodiment of FIG. 21 and FIG. 22 and also illustrates a realistic preparation shape 96 and a generally conical transition 98 from the visible surface to the shaft. In this improved embodiment, ribs 100 have been added between the spherical compliance features to stiffen and strengthen the shaft. Additional material can also be added to any other suitable location of the shaft, for example, all locations of the shaft except immediately adjacent to the upper and lower spheres 88. The ribs 100 are configured to not contact the socket.

Although not shown in many of the embodiments illustrated herein, it may be preferable to configure the contact points such that the die can only be inserted in one orientation. A keying feature can also be used to prevent incorrect orientations.

Implant analog components typically provide mounting features for an abutment that is used to create a crown. The loads on such mounting features can be relatively high making it preferable that the analog be metal. When the analog is metal, cost considerations and material properties may make it preferable to put compliance features in the socket instead of on the analog.

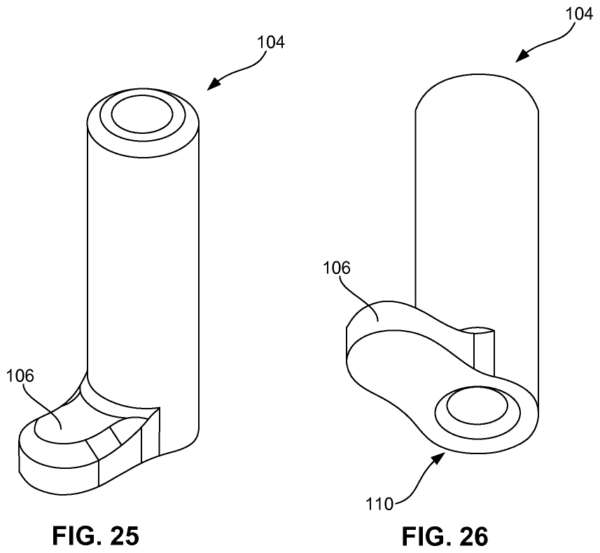

FIG. 24 through FIG. 26 illustrate two implant analog embodiments 102, 104. Each has a single tab feature 106 configured to mate with a corresponding slot in the socket providing a hard stop in the insertion direction and defining the angular position of the analog around the insertion direction. In FIG. 24, a handle 108 is provided for easy removal of the analog 102. In FIG. 26, a tapped hole 110 allows a screw to be used as a temporary handle to remove the analog 104.

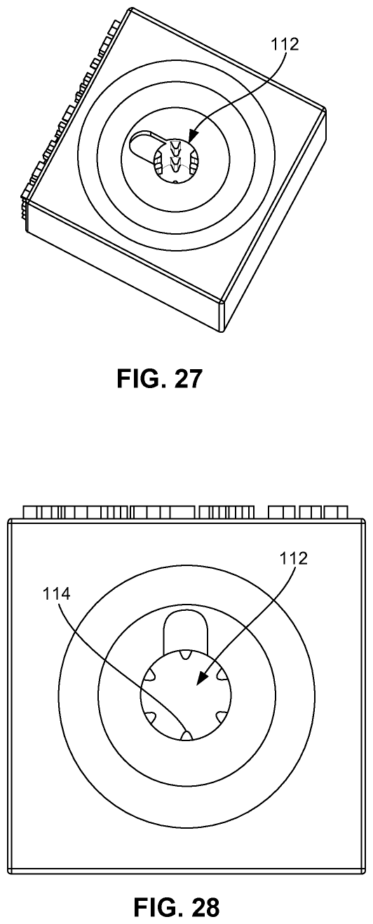

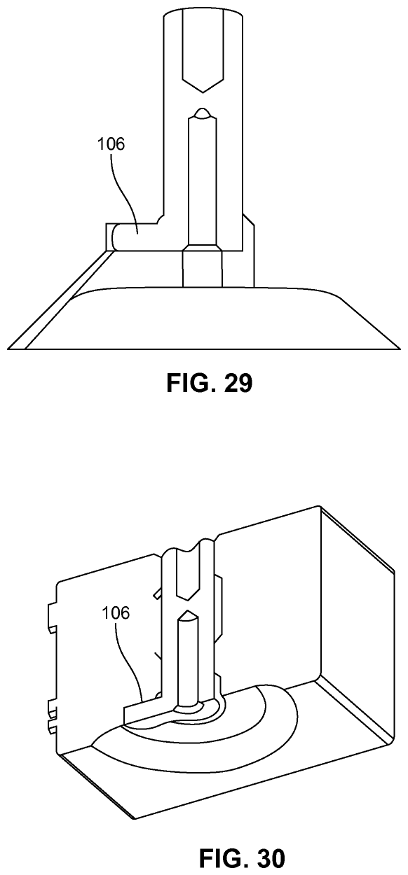

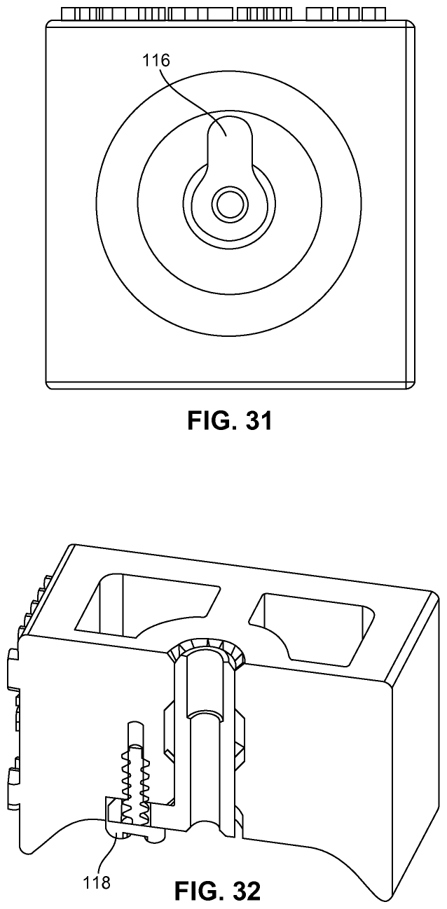

FIG. 27 and FIG. 28 show a socket 112 with multiple compliance portions 114. FIG. 31 shows an implant analog 116 mounted in the socket. FIG. 29 and FIG. 30 show similar embodiments, but without the socket compliance features, and show the top surface of the tab 106 on the analog in contact with the socket to limit the insertion depth. FIG. 32 shows a similar analog mounted in a socket with compliance features. This version adds a screw 118 passing through the analog's tab to provide a firm mounting. The screw 118 prevents inadvertent movement of the analog when an abutment is being mounted on the analog or when a crown is being mounted on the abutment.

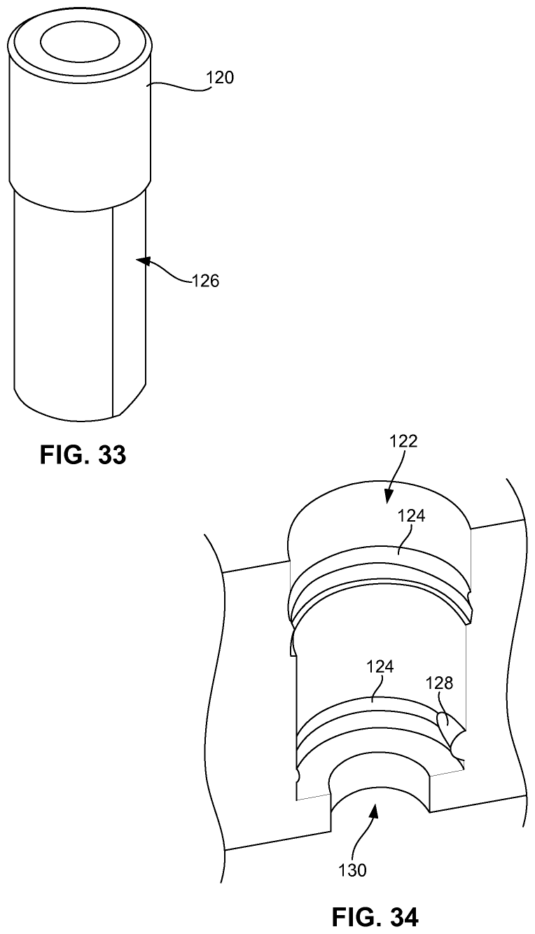

FIG. 33 and FIG. 34 illustrate an embodiment that includes an implant analog 120 and a socket 122 and uses transverse ribs 124 in the socket as the compliant portions. Similar to the embodiment illustrated in FIG. 22, the compliant portions are “stepped” so that the analog 120 can be inserted with almost no force until it is almost seated. The analog 120 has a flat surface 126 that interfaces with a protruding portion 128 of the socket 122 to prevent rotation about the insertion direction. A hole 130 in the bottom of the socket allows a screw to be used to firmly mount the analog 120 in the socket 122. Alternatively, the analog can include a projection, similar to the projection of the embodiment of FIG. 22, that is used to verify the correct insertion depth. When a projection is used, it may be easier and less expensive for the projection's end surface to be perpendicular to the insertion direction and modify the bottom of the jaw model to have a face parallel and flush with that end surface for comparison, rather than having the jaw model bottom be flat and having to cut a custom angle on the analog appropriate for the angle at which the socket is oriented in the jaw model.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A method of providing a dental model comprising:
generating a digital model of a jaw component, wherein the digital model of the jaw component represents at least a portion of a patient's jaw, and wherein the jaw component comprises a socket extending therethrough and a distal surface;
generating a digital model of a dental structure, wherein the dental structure is shaped to be demountably attachable to the jaw component, and wherein the dental structure comprises:
a tooth portion representative of at least a portion of a tooth of the patient,
a shaft shaped to be insertable into the socket along an insertion direction, and
a projection portion, wherein the projection portion protrudes distally from a planar distal end of the shaft, wherein the projection portion is configured to contact the distal surface when the shaft is inserted into the socket along the insertion direction, and wherein contact of the projection portion to the distal surface allows for verification of insertion depth and verification that the dental structure is properly positioned along the insertion direction;
fabricating the jaw component based on the digital model of the jaw component, wherein the jaw component is fabricated using stereolithography; and
fabricating the dental structure based on the digital model of the dental structure, wherein the dental structure is fabricated using stereolithography.

2. The method of claim 1, wherein fabricating the jaw component comprises forming a geometry of the jaw component with a first plurality of polymeric layers, and wherein fabricating the dental structure comprises forming a geometry of the dental structure with a second plurality of polymeric layers.

3. The method of claim 2, wherein the orientation of the first plurality of polymeric layers are not perpendicular to the insertion direction.

4. The method of claim 1, wherein the shaft of the dental structure comprises a three-lobed geometry.

5. The method of claim 1, wherein the shaft of the dental structure comprises a rectangular geometry.

6. The method of claim 1, wherein a friction fit secures the jaw component to the dental structure when the shaft of the jaw component is inserted into the socket of the dental structure along the insertion direction.

7. The method of claim 1, wherein the socket comprises a recess corresponding to a geometry of the projection portion, and wherein the recess is configured to receive the projection portion and limit insertion depth of the projection portion.

8. The method of claim 1, wherein the jaw component further comprises a plurality of protrusions disposed at varying depths along a length of the socket, wherein the plurality of protrusions are configured to provide tactile feedback at the varying depths when the shaft is inserted into the socket.

9. The method of claim 8, wherein at least one of the plurality of protrusions allows for an increased level of compression, and wherein the at least one of the plurality of protrusions is configured to compress when the shaft is inserted into the socket.

10. The method of claim 1, wherein dental structure further comprises a plurality or ribs each extending along the insertion direction.

11. A non-transitory computing device readable medium storing instructions executable by a processor to cause a computing device to perform a method, the method comprising:
generating a digital model of a jaw component, wherein the digital model of the jaw component represents at least a portion of a patient's jaw, and wherein the jaw component comprises a socket extending therethrough and a distal surface;
generating a digital model of a dental structure, wherein the dental structure is shaped to be demountably attachable to the jaw component, and wherein the dental structure comprises:
a tooth portion representative of at least a portion of a tooth of the patient,
a shaft shaped to be insertable into the socket along an insertion direction, and
a projection portion, wherein the projection portion protrudes distally from a planar distal end of the shaft, wherein the projection portion is configured to contact the distal surface when the shaft is inserted into the socket along the insertion direction, and wherein contact of the projection portion to the distal surface allows for verification of insertion depth and verification that the dental structure is properly positioned along the insertion direction;
generating instructions for fabricating the jaw component based on the digital model of the jaw component, wherein the jaw component is fabricated using stereolithography; and
generating instructions for fabricating the dental structure based on the digital model of the dental structure, wherein the dental structure is fabricated using stereolithography.

12. The non-transitory computing device readable medium of claim 11, wherein instructions for fabricating the jaw component comprises forming a geometry of the jaw component with a first plurality of polymeric layers, and wherein instructions for fabricating the dental structure comprises forming a geometry of the dental structure with a second plurality of polymeric layers.

13. The non-transitory computing device readable medium of claim 12, wherein the orientation of the first plurality of polymeric layers are not perpendicular to the insertion direction.

14. The non-transitory computing device readable medium of claim 11, wherein the shaft of the dental structure comprises a three-lobed geometry.

15. The non-transitory computing device readable medium of claim 11, wherein the shaft of the dental structure comprises a rectangular geometry.

16. The non-transitory computing device readable medium of claim 11, wherein a friction fit secures the jaw component to the dental structure when the shaft of the jaw component is inserted into the socket of the dental structure along the insertion direction.

17. The non-transitory computing device readable medium of claim 11, wherein the socket comprises a recess corresponding to a geometry of the projection portion, and wherein the recess is configured to receive the projection portion and limit insertion depth of the projection portion.

18. The non-transitory computing device readable medium of claim 11, wherein the jaw component further comprises a plurality of protrusions disposed at varying depths along a length of the socket, wherein the plurality of protrusions are configured to provide tactile feedback at the varying depths when the shaft is inserted into the socket.

19. The non-transitory computing device readable medium of claim 18, wherein at least one of the plurality of protrusions allows for an increased level of compression, and wherein the at least one of the plurality of protrusions is configured to compress when the shaft is inserted into the socket.

20. The non-transitory computing device readable medium of claim 11, wherein dental structure further comprises a plurality or ribs each extending along the insertion direction.
